(19) United States
(12) Patent Application Publication
(10) Pub. No.: US 2005/0045355 A1
(43) Pub. Date: Mar. 3, 2005

(54) Electrically insulating device for a handling machine

(75) Inventors: Remi Dubail, Cernay (FR); Vincent Vassards, Wittelsheim (FR); Jean-Francois Mougenet, Kingersheim (FR); Guy Riquel, Montigny Sur Loing (FR)

Correspondence Address: Michael L. Kenaga;PIPER RUDNICK LLP, P.O. Box 64807, Chicago, IL, 60664-0807, US

(73) Assignee: ELECTRICITE DE FRANCE Service National

(21) Appl. No.: 10/922,490

(22) Filed: Aug. 18, 2004

(30) Foreign Application Priority Data
Aug. 20, 2003 (FR) FR 03 10051

(51) Int. Cl. B65G 1/00

(52) U.S. Cl. 174/5 SB

(57) ABSTRACT

Electrical insulating device for a handling machine having an arm, said device comprising an electrically insulating insert as a part of said arm, said insert comprising a rigid tubular core made of an electrically insulating material, wherein said core is covered with an elastomeric sheathing which is radially ribbed on the major part of its length.

The invention relates to a device for electrical insulation for a handling machine, and to an aerial lift device equipped with such an electrical insulation device.

In some maintenance operations on high-tension lines there is a need for an operator who stands in a working platform of an aerial lift device and handles the concerned current carrying overhead wire.

Such a handling may be achieved either at a distance from the wire by means of an insulating rod whenever it is possible, or directly when it is required to do so; in such a case, the operator handles the wire with or without insulating gloves.

In case no insulation is provided, the operator might be victim of an electrical shock resulting from the voltage between the conducting wire contacted by the operator and the ground onto which the aerial lift rests.

This is why the working platform has to be electrically insulated from the machine.

The operator also has to be protected against leakage current which circulates from the electric line towards the ground.

The lift devices are generally equipped with a deployable lifting mechanism, which comprises several moveable arms, the cinematic of which may be either of the compass type (i.e. the arms are pivotable) or of the telescopic type (i.e. the arms are slideable).

It is known in the art to equip the top arm, the end of which holds the working platform, with an electrical insulating insert or “boom” forming part of the arm. Such an insert is e.g. comprised of a tubular part interposed between two conducting portions of the arm.

Although such an insert prevents electric shock, it does not completely prevent propagation of leakage current, especially by rainy weather, when the machine is covered with an electrically conductive aqueous film which facilitates propagation of leakage current.

Therefore, in order to prevent propagation of leakage current, it is known to increase the length of the insulating boom so as to increase the creepage distance, i.e. the distance that the leakage current must cover from one electrically conductive portion adjacent the insulating boom to the other.

It is also known to cover the surface of the insulating boom with a silicon film, so as to prevent retention of water drops and therefore prevent creation of an aqueous film onto the insulating boom.

From European patent application No. EP-0 940 366, there is known an aerial lift device the top arm of which comprises a radial disk, so-called “umbrella”, coated with a silicon varnish, so as to increase waterproof quality of the arm and limit propagation of the leakage current.

Such a technology is satisfactory as long as weather and field conditions are good.

However, by strong rain, there may appear on the upper surface of the umbrella a water plash which, while dropping onto the lower portion of the arm, facilitates propagation of leakage current instead of preventing it, thereby increasing the risk of short circuit.

In addition, due to its size, the umbrella may hit or even get stuck in obstacles (like tree branches), thereby destroying the silicon varnish and decreasing the efficiency of the insulating boom. The umbrella might also be torn from the machine, which results in stopping the latter in order to do the necessary repairing.

The invention aims at overcoming the above mentioned drawbacks, by providing an electrical insulating device which limits propagation of leakage current even by bad weather, and which is strong enough to allow power line work in any field condition.

Therefore, the invention provides an electrical insulating device for a handling machine having an arm, said device comprising an electrically insulating insert as a part of said arm, said insert comprising a rigid tubular core made of an electrically insulating material, wherein said core is covered with an elastomeric sheathing which is radially ribbed on the major part of its length.

Creepage distance of the insulating insert is therefore increased, as the insert remains compact.

In addition, by strong rainy weather, the ribbed sheathing efficiently drains water, thereby preventing creation at the surface of the insert of a conductive aqueous film.

Furthermore, as the sheathing is somewhat resistant to collision and friction against some obstacles in the vicinity of the working zone, the strength of the insert is thereby increased.

The invention is also directed to an aerial lift device comprising such an insulating device.

The sheathing is preferably so ribbed that the ratio between the creepage distance and the overall length of the insert is upper than or equal to 2.

Therefore, the resistance to propagation of leakage current is twice more than that of a known tubular insert having the same overall length. The ratio may be comprised between 2 and 3.

In a particular embodiment, the sheathing is made of silicon and comprises a continuous helical rib, which may be inclined with respect of a plane perpendicular to the axis of the insert.

The core of the insert is preferably made of a composite material, such as glass fiber.

Furthermore, the insulation device may comprise a connector rigidly attached to one end of the insert, and fixed to a tubular part adjacent the arm of the handling machine.

In one particular embodiment, the insert is interposed between two coaxial parts of the arm of the handling machine, and the insulation device comprises two connectors rigidly attached to respective ends of the insert and to respective coaxial parts.

The core of the insert and the connectors may together define a tight cavity, allowing passage of a control cable.

The connector may be glued and/or screwed or pinned to the corresponding end of the insert.

In addition, the insulating device may comprise a device for dehumidifying said cavity. For instance, this dehumidification device comprises a gas supply connected to said cavity and maintaining said cavity at a gas pressure higher than the atmospheric pressure, thereby preventing moisture and dust (which facilitate propagation of leakage current) from penetrating into the cavity.

The gas is preferably an inert gas, such as nitrogen. A dessicant material may also be placed in the cavity.

The above and other objects and advantages of the invention will become apparent from the detailed description of a preferred embodiment of the invention, considered in conjunction with the accompanying drawings.

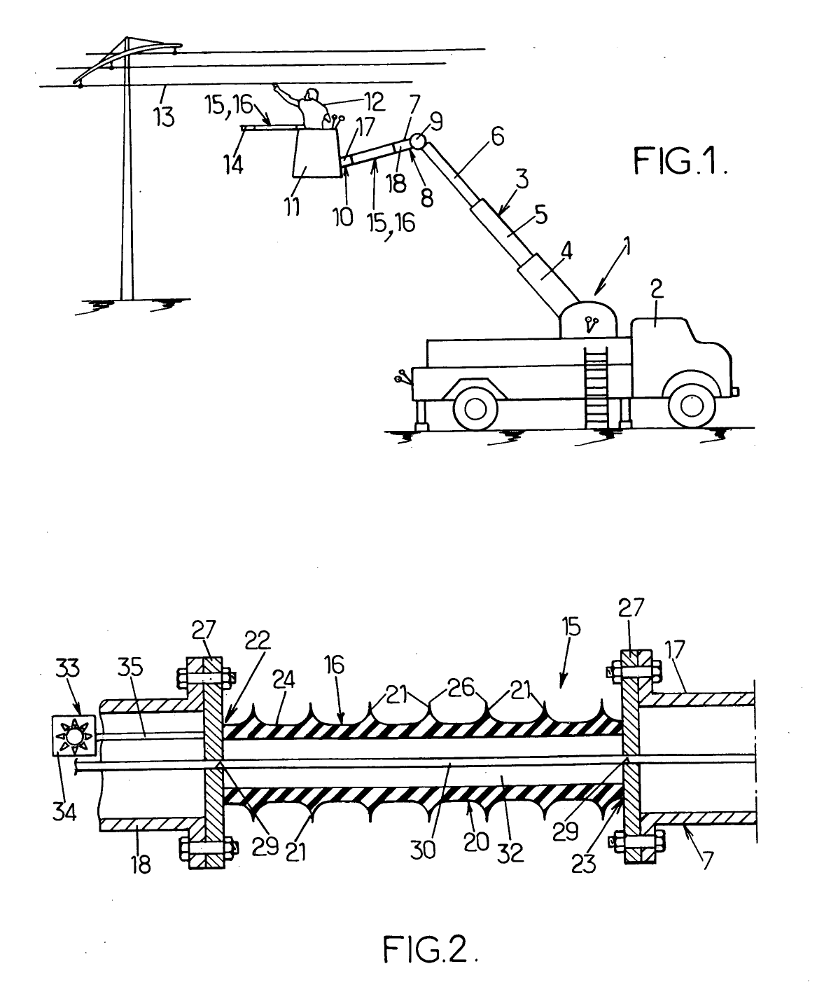

FIG. 1 is an elevational side view of an aerial lift device equipped with a telescopic mechanism comprising an electrical insulating device.

FIG. 2 is a detailed cut view of the aerial lift device of FIG. 1, showing the electrical insulating device.

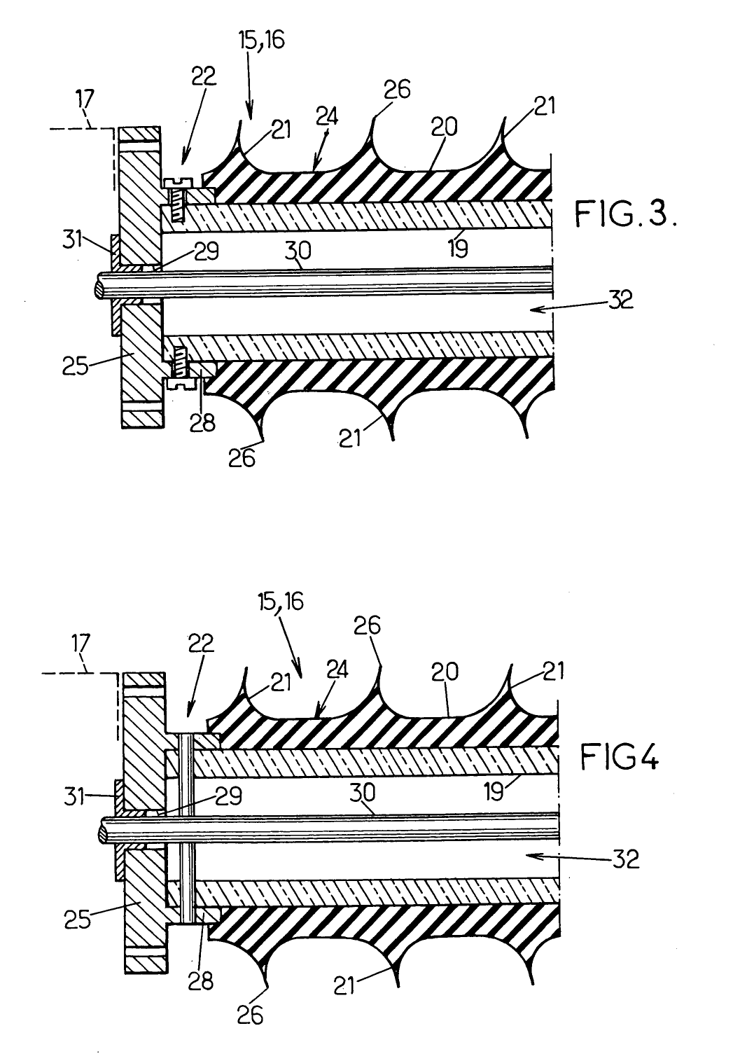

FIG. 3 is a detailed cut view of the electrical insulating device of FIG. 2.

FIG. 4 is a view similar to FIG. 3, according to another embodiment.

A handling machine 1 is represented on FIG. 1. Here, handling machine 1 is an aerial lift device utilized for maintenance of power lines, and more specifically high-tension lines. Lift 1 comprises an automotive vehicle 2 equipped with a telescopic lifting mechanism 3 comprising a plurality of sliding arms 4, 5, 6 nested within each other.

Lift 1 also comprises, in the embodiment shown on FIG. 1, a pivotable top end arm 7 which is connected, through a lower end 8, to the last arm 6 of the lifting mechanism 3, by means of a hinge 9. Arm 7 holds at an upper end 10 one or more working platforms 11 in which operators 12 can stand in order to work on a conductive power line 13.

As depicted on FIG. 1, platform 11 comprises a mast 14 allowing platform 11 to rest on the power line or to maintain the operator 12 at a distance from the power line in order to facilitate work on the line 13.

During manual operation without insulating gloves, the operator 12 is at the same electric potential as the power line 13 (so is the working station 11), whereas the vehicle 2 is at the ground potential.

Therefore, in order to protect the operator against any electric shock, the machine 1 is equipped with a device 15 for electrically insulating the working station 11 from the rest of the machine 1. As will be hereinafter described, device 15 is such designed as to prevent propagation of leakage current from power line 13, especially by rainy weather.

As depicted on FIG. 1, the electrical insulating device 15 comprises an insert or “boom” which is electrically insulating, and which forms a part of the top end arm 7. Boom 16 is interposed between two coaxial parts of the top end arm, namely an upper part 17 located on the side of the working station 11, and a lower part 18 located on the side of the hinge 9.

As depicted on FIGS. 2 to 4, the boom 16 is generally cylindrical. It comprises a rigid tubular core 19, manufactured in an electrically insulating material, made of in silicon, which is radially ribbed on the major part of its length.

The sheathing 20 comprises e.g. a series of spaced apart ribs. However, in the depicted example, sheathing 20 has a helical rib 21 which goes all through the length of the boom 16.

The core 19 forms the body of the boom 16; it supports the weight comprised of the working stations 11 and the operators 12. The core 19 is preferably made of a composite material, such as glass fiber, thereby giving the boom 16 excellent mechanical properties as regards bending and torsional strength, together with a good electrical resistivity.

The sheathing 20 may be fixed to the core 19 by means of any known cable sheathing technique, such as extrusion coating; although such a technique should be adapted in order to form the helical rib 21.

A helical rib 21 with constant (see FIGS. 2 to 4) or variable pitch may thus be obtained in function of the settings of the extruding machine.

In the embodiment of FIGS. 3 and 4, the rib 21 has in section an asymmetric shape. It is inclined with respect of a plane perpendicular to the axis A of the boom 16, from the upper part 17 toward the lower part 18, thereby providing better flowing capabilities of the rain water.

Let 1 be the overall length of the boom 16, i.e. the shortest distance from one end 22 to the other end 23 of the boom 16, parallel to the axis A.

And let L be the creepage distance of the boom 16, i.e. the axial distance between the ends 22, 23 taken along the contour of the external surface 24 of the sheathing 20.

It can be easily understood that, due the radial rib 21, the creepage distance L is higher than the overall length 1 of the boom 16.

As the boom 16 electrically insulates the upper and lower portions 17, 18 from each other, the leakage current coming from the power line 13 must circulate through the external surface 24 of the sheathing 20, thereby covering the creepage distance L.

Therefore, with respect of a common tubular boom having the same overall length, the boom 16 has an increased resistance to propagation of leakage current, the ratio R=L/1 being variable in function of the shape of the rib 21, in particular of its overall diameter.

Accordingly, one can design rib 21 so as to make ratio R upper than or equal to 2, and for example comprised between 2 and 3.

For example, R being equal to 3, the boom presents, with respect of a common tubular boom having the same resistance to propagation of leakage current, a length which is three times less.

In other words, a 1 m-long boom 16 has the same resistance to leakage current propagation as a 3 m-long common tubular boom.

In addition, using silicon (which is a hydrophobic material) provides water scattering in fine water drops, thereby preventing creation of a conductive aqueous film.

The boom 16 is therefore lighter and more compact than the known booms. Being more compact, the boom 16 has a better mechanical strength both in flexion and torsion, thereby giving the arm 7 a better rigidity.

As the boom 16 is short, it can equip a telescopic-type lift device, as depicted in FIG. 1, whereas the lift remains compact with respect of common lift devices.

In addition, due to its shape, as depicted on FIGS. 2 and 3, rib 21 efficiently drains rain water during bad weather work.

More specifically, due to its sharp-pointed (V-shaped) section, the rib 21 has a peripheral edge 26 which facilitates water dropping and drying of the surface 24 of the sheathing 20, thereby preventing creation of a continuous conductive aqueous film onto the surface 24.

As depicted on FIG. 3, the sheathing 20 is not a simple film covering the core, but a layer which is thick with respect of the radial thickness of the core 19, such a layer being collision- and friction-resistant, e.g. when branches are in the vicinity of the working area. Such a resistance is increased by softness and flexibility of the rib 21, thereby giving the boom 16 a long life duration without making it necessary to often repair or replace the boom 16.

Whenever it is however necessary to repair the sheathing, it is sufficient to achieve a local over molding, which does not stop the boom 16 too long.

On the other hand, the boom 16 is so mounted as to insure not only mechanical continuity of the top end arm 7, but also transmission of movements of the working station 11 and also its functional equipment.

As depicted on FIG. 2, the insulating device 15 comprises two connectors 27 attached to the ends 22, 23 of the boom 16.

Each connector 27 comprises e.g. a disk 25 with a tubular portion 28, coaxial with the boom 16, protruding from the disk 2, said tubular portion 28 being encased in the end of the core 19 and glued thereto.

The tubular portion 28 is also preferably radially screwed (FIG. 3) or radially pinned (FIG. 4) to the core.

As depicted on FIG. 2, the connectors 27 are thereafter screwed to the upper and lower parts 17, 18.

The boom 16 is thereby strongly attached to the upper and lower parts 17, 18 of the arm 7. In particular, screwing or pinning the connectors 27 to the core prevents rotation of the boom 16 with respect of the upper and lower parts 17, 18, thereby maintaining proper orientation of the working platform 11.

The connectors 27 are made of a material (e.g. steel or aluminum alloy) strong enough to insure rigidity of the mechanical interface between the upper and lower parts 17, 18 of the arm 7 and the boom 16.

In case power transmission to the working platform 11 is achieved by means of mechanical links, the connectors 27 may be provided with holes 29 for passage of a control rope 30 through the connector 27.

A cover 31 is encased into the hole 29 in order to ensure tight passage of the control rope through the connector 27.

In addition, in order to prevent moisture or dust from coming into the cylindrical cavity 32 provided inside the boom 16 for passage of the control rope, and limited by the core and connectors 27, the insulating device 15 comprises a device 33 for dehumidification of the cavity 32.

Such device 33 comprises a gas supply 34 connected to cavity 32 through a conduit 35 going through one of the connectors 27.

The gas supply 34 is so designed as to maintain inside the cavity a gas pressure higher than atmospheric pressure. The gas supply 34 may comprise a compressor or a pressure regulator connected to a gas tank (not shown).

The overpressure inside the cavity 32 limits penetration of moisture and dust therein.

In addition, a plug made of dessicant material may be positioned inside the cavity 32 in order to retain water vapor by means of molecular interaction.

Once the dessicant product (e.g. activated alumina, molecular sieve, or even silicagel) has come to saturation, it can be replaced.

The supplied gas is preferably an inert gas (such as nitrogen) chosen for its lack of chemical reactivity with the components of the electrical insulating device 15, so as to prevent corrosion of the connectors 27.

1. Electrical insulating device for a handling machine having an arm, said device comprising an electrically insulating insert as a part of said arm, said insert comprising a rigid tubular core made of an electrically insulating material, wherein said core is covered with an elastomeric sheathing which is radially ribbed on the major part of its length.

2. Insulating device according to claim 1, wherein the sheathing is so ribbed that the ratio between the creepage distance and the overall length of the insert is upper than or equal to 2.

3. Insulating device according to claim 2, wherein said ratio is comprised between 2 and 3.

4. Insulating device according to claim 1, wherein said sheathing is made of silicon.

5. Insulating device according to claim 1, wherein said sheathing comprises a continuous helical rib.

6. Insulating device according to claim 5, wherein said rib is inclined with respect of a plane perpendicular to the axis of the insert.

7. Insulating device according to claim 1, wherein the core of the insert is made of a composite material.

8. Insulating device according to claim 7, wherein said core is made of glass fiber.

9. Insulating device according to claim 1, comprising a connector rigidly attached to one end of the insert, and fixed to a tubular part adjacent the arm of the handling machine.

10. Insulating device according to claim 9, wherein the insert is interposed between two coaxial parts of the arm of the handling machine, and wherein the insulation device comprises two connectors rigidly attached to respective ends of the insert and to respective said coaxial parts.

11. Insulating device according to claim 10, wherein the core of the insert and the connectors together define a tight cavity.

12. Insulating device according to claim 10, wherein said connector is glued to the corresponding end of the insert.

13. Insulating device according to claim 10, wherein the connector is screwed or pinned to the insert.

14. Insulating device according to claim 1, wherein said insert defines a tight internal cavity, and wherein said insulating device comprises a device for dehumidifying said cavity.

15. Insulating device according to claim 14, wherein said dehumidification device comprises a gas supply connected to said cavity and maintaining said cavity at a gas pressure higher than the atmospheric pressure.

16. Insulating device according to claim 15, wherein said gas is an inert gas.

17. Insulating device according to claim 14, wherein said dehumidification device comprises a dessicant material positioned inside the cavity.

18. Aerial lift device comprising an insulating device according to any of claims 1 to 17.
